(19) United States
(12) Patent Application Publication
(10) Pub. No.: US 2024/0142769 A1
(43) Pub. Date: May 2, 2024

(54) PROJECTION MODULE

(71) Applicant: Robert Bosch GmbH, Stuttgart (DE)

(72) Inventors: Maximilian Busch, Eningen Unter Achalm (DE); Thomas Kuenstle, Reutlingen (DE)

(21) Appl. No.: 18/548,253

(22) PCT Filed: Jun. 8, 2022
(86) PCT No.: PCT/EP2022/065510

§ 371 Date: Aug. 29, 2023

(30) Foreign Application Priority Data
Jul. 6, 2021 (DE) 10 2021 207 081.7

(51) Int. Cl. G02B 26/08; G02B 26/10; G02B 27/01

(52) U.S. Cl. CPC G02B 26/0833; G02B 26/105; G02B 27/0172; G02B 27/0176

(57) ABSTRACT

A scanning laser projection module which is suitable for consumer applications because of its very compact design. The projection module includes an actuable laser module having at least one laser source for emitting a laser beam of a predefinable intensity, an actuable micromirror array for deflecting the at least one laser beam, a mounting support having a support front side and a support rear side and a beam-deflection system. The laser module is situated on the support front side, and the micromirror array is situated on the support rear side. The beam-deflection system is configured in such a way that the at least one laser beam is steered from the laser module on the support front side onto the micromirror array on the support rear side.

### BACKGROUND INFORMATION

The present invention relates to a projection module for use in consumer applications such as VR (virtual reality) or AR (augmented reality) smart glasses. In these applications, images or also only supplementary information is/are projected into a user's the field of vision with the aid of a scanning projection module. One such realization possibility is projecting the two-dimensional image information directly onto the retina, which is also known as a retina scanning method. However, the image information may also be projected onto one lens or both lenses of the smart glasses with the aid of optical waveguides. This variant is called a waveguide method.

In both cases, the projection module includes an actuable laser module which has at least one laser source for emitting a laser beam of a predefinable intensity. RGB (red, green, blue) laser modules having semiconductor laser diodes featuring different wavelength ranges are frequently used for this purpose. In addition, such a projection module includes an actuable micromirror array for deflecting the laser beam, the micromirror array being responsible for the scanning movement of the laser beam. A micromirror array of this type often includes two mirrors, of which one is responsible for a horizontal movement of the laser beam while the other mirror induces a vertical movement of the laser beam. In this way, the image information is able to be projected into successive frames, each frame being made up of individual lines. However, the use of micromirror arrays having only one mirror are also possible, which deflects the laser beam both horizontally and vertically. This likewise allows the laser beam to be guided line-by-line across the projection surface or to execute also other scanning movements such as a Lissajou-type movement.

In retina scanning methods, the laser beam is steered onto a holographic or optically active element in the region of the lenses with the aid of the micromirror array. Using this holographic or optically active element, the laser beam is then directed to the eye of the user. To this end, the projection module must be positioned in a defined position and alignment relative to holographic or optically active element in the region of the lens of the glasses. In the waveguide method, the output beam of the micromirror array is coupled into a lens of the glasses, which acts as an optical waveguide for the laser beam deflected by the micromirror array. To this end, the eyeglass lens includes a locally defined coupling structure for the laser beam and a locally defined exit structure in the field of view of the user. Here, the projection module must be positioned in a defined position and alignment relative to the coupling structure of the lens. In both cases, very small tolerance fields should be observed in the positioning and alignment of the projection module because deviations may have a considerable effect on the user perception.

### SUMMARY

Especially in consumer applications, for instance VR/AR smart glasses, the integration of a projection module into a higher-order overall system is challenging in many regards. In view of a mobile use, the most space-saving, compact design, which furthermore allows for the integration into different designs of the overall system, is endeavored. The integration of the projection module into the higher-order overall system should be as uncomplicated as technically possible. In particular, the projection module should be able to be positioned, aligned and adjusted very easily and precisely in relation to the other optical components of the higher-order overall system. In the case of VR/AR smart glasses, the design should be based on a standard eyeglass geometry. The wear comfort of the user plays an essential role in this context. Safety aspects when the use occurs in close proximity to the eye must be observed in addition.

According to the present invention, a scanning laser projection module is provided, which is particularly suitable for consumer applications on account of its very compact design. According to an example embodiment of the present invention, the projection module according to the present invention includes an actuable laser module having at least one laser source for emitting a laser beam of a predefinable intensity, and an actuable micromirror array for deflecting the at least one laser beam. In addition, the projection module according to the present invention includes a mounting support having a support front side and a support rear side and a beam-deflection system. According to the present invention, the laser module is situated on the support front side, the micromirror array is situated on the support rear side, and the beam-deflection system is configured in such a way that the at least one laser beam is directed from the laser module on the front side of the support onto the micromirror array on the rear side of the support.

According to an example embodiment of the present invention, both the support front side and the support rear side of the mounting support are used as mounting surfaces. This enables an especially compact and simple design of the projection module. In addition, a selective and partitionable heat dissipation is able to be realized for individual component groups of the projection module, in particular for the laser module on the support front side and the micromirror array on the support rear side, but also for the beam-deflection system. The most optimal heat dissipation is also advantageous for further components of the projection module whose relative positioning and alignment are critical and which are subject to thermal influences. For example, the mounting concept according to the present invention allows optical elements for combining beams (beam combiner), for the beam aligning and beam shaping to be positioned, possibly combined in one component group, either on the support front side or on the support rear side, so that an excellent heat dissipation is able to be achieved.

Further measures that contribute to a compact design of the projection module according to an example embodiment of the present invention are the positioning of the laser module on the support front side in such a way that the laser beam is emitted essentially parallel to the support front side, and to configure the beam-deflection system in such a way that the laser beam is essentially directed parallel to the support rear side onto the micromirror array. In this variant, further optical elements may easily be mounted on the mounting support, both on the support front side and the support rear side, in order to position them in the beam path between the laser module and the micromirror array. This results in many optimization possibilities with regard to compactness and heat dissipation. In one advantageous variant, such optical elements for the beam combining and/or a beam aligning and/or beam shaping of the laser beam are situated on the support front side between the laser module and the beam-deflection system. It is especially advantageous if the laser module and the micromirror array are placed and the beam-deflection system is configured in such a way that the laser beam is directed essentially in a U-shape from the laser module on the support front side to the micromirror array on the support rear side. In this way, the laser module and micromirror array can be positioned in a particularly space-saving manner opposite one another on the front and rear side of the mounting support.

The laser beam emitted by the laser module is able to be guided with the aid of the beam-deflection system via an outer edge of the mounting support from the support front side to the support rear side. This must be especially taken into account when the projection module is installed. According to an example embodiment of the present invention, it is advantageous for the easiest integration of the projection module in a higher-order overall system if the mounting support has a through hole and the beam-deflection system is positioned and configured in such a way that the laser beam is directed from the laser module on the support front side through the through hole to the micromirror array on the support rear side.

The optical function of the beam-deflection system of the projection module according to an example embodiment of the present invention may basically be achieved with the aid of a single correspondingly configured optical element. However, the beam-deflection system may also include a plurality of optical elements whose interaction induces the beam deflection of the laser beam. The individual optical elements may advantageously be positioned in a spatially distributed fashion, that is, a first optical element on the support front side and a second optical element on the support rear side and/or a further optical element in the region of the through hole of the mounting support.

In one advantageous example embodiment of the projection module according to the present invention, the beam-deflection system is additionally configured to decouple at least a partial beam of the laser beam. The partial beam may then be used to monitor the function of the projection module, for instance. It is advantageous in this context if a light sensor such as a photodiode is positioned in the beam path of the decoupled partial beam. Such a light sensor is able to be utilized for different system- and safety-relevant controls or actuations of the laser module and/or the micromirror array. Mentioned as examples here are the color balance and brightness balance and also the eye safety monitoring.

In one example embodiment of the projection module according to the present invention, the electrical contacting of the laser module and/or the micromirror array and/or the light sensor is realized via at least one circuit board which is fixed in place on the mounting support. Particularly advantageous is the use of flexible circuit boards, which enables a variable installation of the electronic component required for the operation and a flexible positioning of the electrical connection interface with regard to a higher-order overall system.

The mounting support of the projection module according to an example embodiment of the present invention may be equipped with at least one internal mechanical interface, which supports an adjusted mounting of individual components such as the laser module, the micromirror array and/or the beam-deflection system on the mounting support. This considerably simplifies the production of the projection module according to the present invention, for instance especially if preassembled component groups are used for the laser module and the micromirror array, which are then positioned and fixed in place on the mounting support in a mounting step.

As mentioned above, the integration of the projection module into the higher-order overall system should be as uncomplicated as possible. More specifically, the positioning, alignment and adjustment of the projection module relative to the other optical components of the higher-order overall system should be very easy and precise. To this end, the mounting support of the projection module according to an example embodiment of the present invention may include at least one external mechanical interface. This external mechanical interface has two functions. On the one hand, it forms a reference surface for the calibration and the optical alignment of the laser module, micromirror array, beam-deflection system and the optical elements for the beam combining, beam orientation and/or beam shaping. In this function, the external mechanical interface is therefore already utilized in the alignment and calibration process during the production of the projection module. On the other hand, it facilitates an adjusted installation of the projection module in a higher-order overall system. Such an external mechanical interface may simply be realized in the form of a mechanical stop and/or mechanical fastening means, which cooperates with a corresponding mechanical interface of the higher-order overall system to prevent a translatory movement in at least one direction in space, i.e., a linear displacement, and/or a rotatory movement about at least one direction in space, i.e., a rotation.

On the whole, the mounting concept for a projection module according to the present invention allows for a system-spanning approach for realizing the best compromise between weight, size, assembly, robustness, serial production capability and costs. As mentioned above, the compact design of the projection module according to the present invention makes it particularly suited for use within the framework of consumer applications such as VR/AR smart glasses. However, it should expressly be pointed out that the projection module of the present invention may also be used in other higher-order overall systems such as from the automotive field or an industrial environment.

### BRIEF DESCRIPTION OF THE DRAWINGS

Advantageous embodiments and further developments of the present invention will be described in the following text using the example of a projection module for VR/AR smart glasses based on the figures.

FIG. 1 shows a method of functioning of VR/AR smart glasses using a retina scanning method, according to an example embodiment of the present invention.

FIG. 2 shows the assembled support front side of the mounting support of a projection module according to an example embodiment of the present invention.

FIG. 3 shows the assembled support rear side of the mounting support shown in FIG. 2, according to an example embodiment of the present invention.

FIG. 4 shows a perspective view of the projection module shown in FIGS. 2 and 3.

FIG. 5 shows the projection module shown in FIGS. 2 to 4 integrated into or mounted on frame temples of VR/AR smart glasses, according to an example embodiment of the present invention.

### DETAILED DESCRIPTION OF EXAMPLE EMBODIMENTS

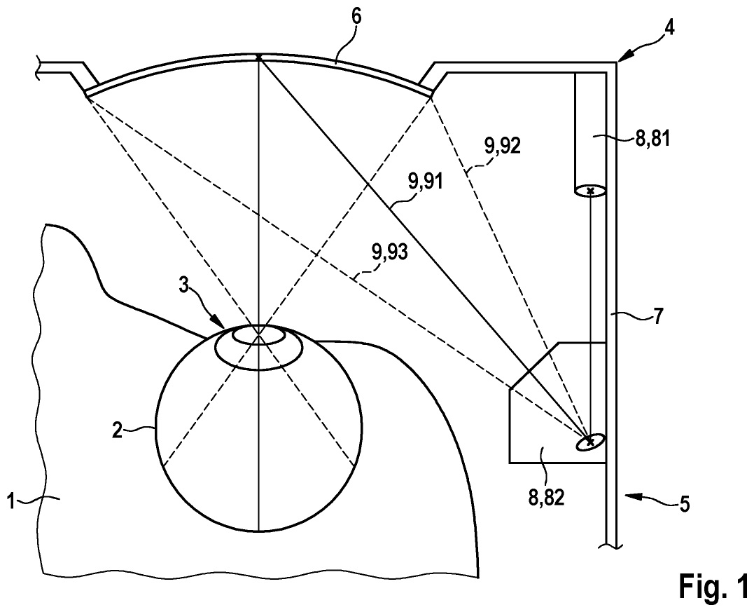

FIG. 1 is a schematic partial representation of the user of VR/AR smart glasses in a view from above. Visible is part of head 1 with right eye 2 of the user, the entire ocular globe including pupil 3 being shown. In addition, FIG. 1 shows part of VR/AR smart glasses, that is, glasses frame 5 with right lens 6 and the front part of right temple 7. Situated on this part of temple 7 is an actuable projection module 8, which includes at least one laser module 81 and a micromirror array 82. Projection module 8 is used to project image information onto right lens 6. To this end, laser beam 9 generated by laser module 81 is directed in a scanning movement across a projection region of right lens 6 with the aid of micromirror array 82, which is illustrated here by the representation of central position 91 of laser beam 9 and the two positions 92 and 93 of laser beam 9 maximally deflected to the right and left. The projection region of lens 6 is provided with a holographic function to steer laser beam 9 onto pupil 3, and thus onto the retina of the user, in the most optimal manner in every scanning position.

For one, FIG. 1, for example, demonstrates that a projection module of the type discussed here should be as small and compact as possible already by the very fact of its usage location, which is the temple in this case. For another, FIG. 1 shows that the use of a projection module in the frame of VR/AR smart glasses places great demands on an exact adjustment in relation to the other components of the overall system, in particular the holographic function of the lens.

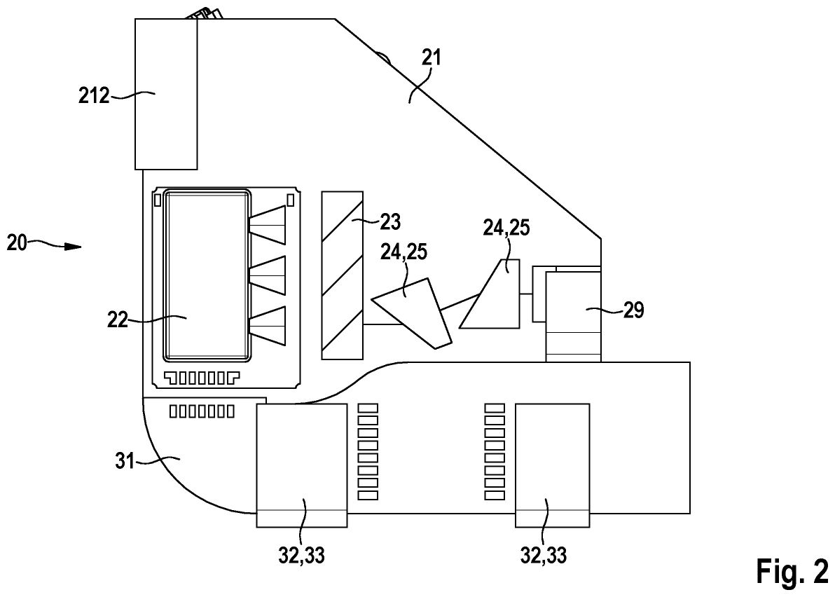

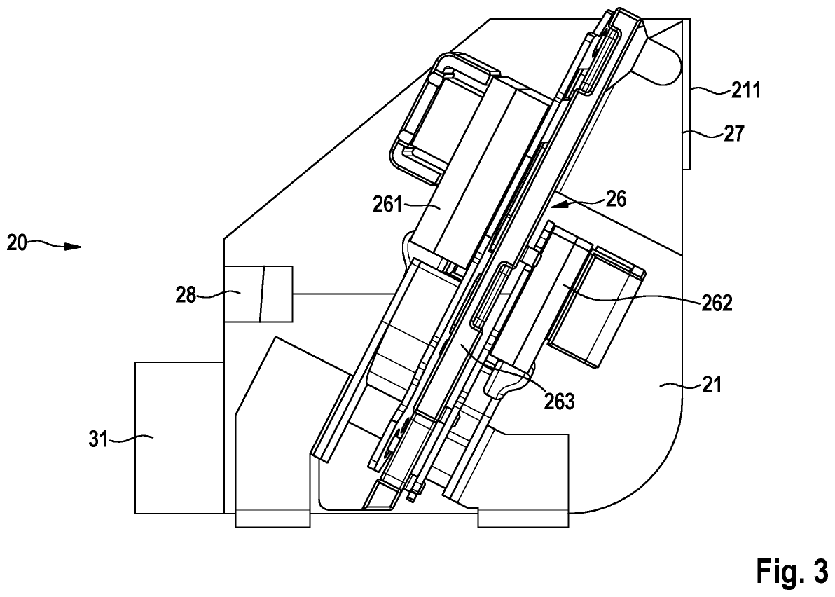

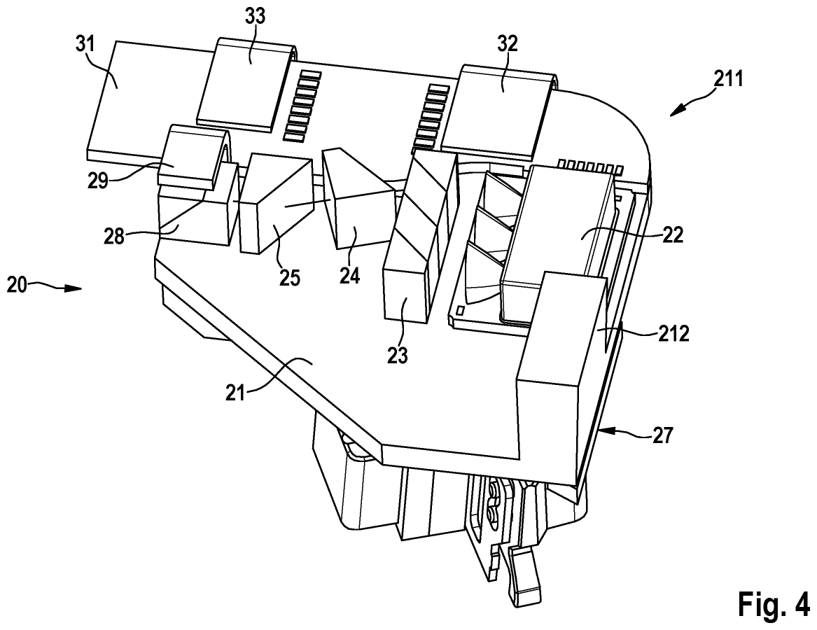

An essential aspect of the provided projection module is the distribution of the individual components to the front and rear side of a mounting support. This will be described in greater detail in the following text with the aid of FIGS. 2 to 4. To this end, FIG. 2 shows the assembled support front side, and FIG. 3 shows the assembled support rear side of mounting support 21 of a projection module 20 according to the present invention, while entire projection module 20 is shown in FIG. 4 in a perspective side view.

Projection module 20 includes an actuable laser module 22 provided with three laser diodes R, G, B as laser sources. The three laser diodes R, G, B transmit laser light of a different wavelength and predefinable intensity, preferably red (R), green (G), and blue (B) light. The light intensity of each individual laser diode R, G, B is controlled as a function of the image information to be projected. Laser module 22 is disposed on the support front side in this case, i.e., in such a way that the laser radiation generated by the laser diodes R, G, B is essentially emitted parallel to the support front side. These individual beams are combined to form a total beam with the aid of an optical system for beam combining, which may be made up of only one or also multiple optical element(s) and is referred to as beam combiner 23. The full beam is then aligned and formed with the aid of further optical elements, in this case two beam-shaping prisms 24 and 25, the full beam extending parallel to the support front side even after emerging from prisms 24 and 25. As may be gathered from FIG. 2, both beam combiner 23 and beam-shaping prisms 24, 25 are likewise mounted on the support front side in the exemplary embodiment described here.

For the deflection of the full beam for a scanning projection of image information, projection module 20 furthermore includes an actuable micromirror array 26, which is situated on the support rear side according to the present invention. In the illustrated exemplary embodiment, micromirror array 26 is a preassembled component group having a first actuable micromirror component 261 for a horizontal deflection of the full beam, and a second actuable micromirror component 262 for the vertical deflection of the full beam. The two micromirror components 261, 262 are mounted on what is known as a skeleton holder 263, more specifically, mounted in defined positions at a defined distance and a defined orientation relative to one another, as may be gathered from FIG. 3. An adjusted mounting of skeleton holder 263 on the support rear side of mounting support 21 is considerably simplified in that mounting support 21 has a defined edge 211 as an internal mechanical interface for skeleton holder 263, which is provided with a corresponding stop edge 27.

According to the present invention, the laser beams or the full beam which laser module 22 generates on the support front side is/are directed onto micromirror array 26 on the support rear side with the aid of a beam-deflection system 28. In the illustrated exemplary embodiment, beam-deflection system 28 is situated in a recess in the edge region of mounting support 21 so that it is depicted both in FIG. 2 and in FIG. 3. However, the mounting support could also have a through hole by way of which the full beam is directed with the aid of the beam-deflection system from the laser module on the support front side onto the micromirror array on the support rear side. Beam-deflection system 28, for example, may be realized in the form of a single deflection prism. However, it may also include a plurality of optical elements whose interaction induces the beam deflection of the full beam.

In the exemplary embodiment described here, as mentioned above, it is not only laser module 22 that is positioned and aligned on the support front side such that the laser radiation generated by laser diodes R, G, B is essentially emitted parallel to the support front side. The optical elements, beam combiner 23 and prisms 24 and 25 for the beam shaping of the full beam, are also positioned and aligned on the support front side between laser module 22 and beam-deflection system 28 in such a way that the entire laser beam extends essentially parallel to the support front side. In addition, beam-deflection system 28 is configured so that the full beam is essentially directed parallel to the support rear side onto micromirror array 26. FIGS. 2 and 3 show that laser module 22 together with optical elements 23, 24, 25 on the support front side and micromirror array 26 on the support rear side are situated opposite one another so that the laser radiation or the full beam generated by laser diodes R, G, B is directed essentially in a U-shape from laser module 22 on the support front side to micromirror array 26 on the support rear side, which contributes to an especially compact design of projection module 20.

Beam-deflection system 28 of projection module 20 described here is configured to decouple at least a partial beam from the full beam and to direct it onto a light sensor 29, e.g., a photodiode, which is situated on beam-deflection system 28 in this case. This light sensor 29 is able to be used in a wide variety of ways, e.g., for monitoring the function of projection module 20 and for control purposes such as a white balance or a brightness balance control, or also for monitoring of and compliance with eye-safety functions.

The electrical contacting of the individual components of the described projection module 20 is implemented via a flexible circuit board 31, which was laminated onto the support front side of mounting support 21 in a first mounting step. Next, the preassembled component group of micromirror array 26 was mounted on the support rear side, for which defined edge 211 of mounting support 21 on the one hand and corresponding stop edge 27 of skeleton holder 263 on the other hand were utilized for a defined alignment of micromirror array 26 relative to the mounting support. The two flexible circuit boards 32, 33 for the electrical contacting of the two micromirror components 261, 262 were folded over onto flexible circuit board 31 on the support front side and connected and fixed in place there. The components, laser module 22, beam combiner 23 and prisms 24, 25, were then mounted on the support front side. In a separate alignment step, the individual laser diodes R, G, B and beam combiner 23 were aligned relative to one another before beam-deflection system 28 was positioned and aligned with regard to the components on the support front side and micromirror array 26 on the support rear side.

Mounting support 21 of the described embodiment of a projection module 20 according to the present invention is equipped with an external mechanical interface 212. This external mechanical interface 212 forms a reference surface for the calibration and the optical alignment of laser module 22, micromirror array 26, beam-deflection system 28, and the optical elements beam combiner 23 and prisms 24, 25. As may be gathered especially from FIG. 4, the external mechanical interface is realized in the form of a mechanical stop 212 here, which—in cooperation with a corresponding mechanical interface at the installation location of projection module 20—prevents a translatory movement in at least one direction in space and/or a rotatory movement about at least one direction in space. This facilitates an adjusted installation of projection module 20 in a higher-order overall system such as VR/AR smart glasses.

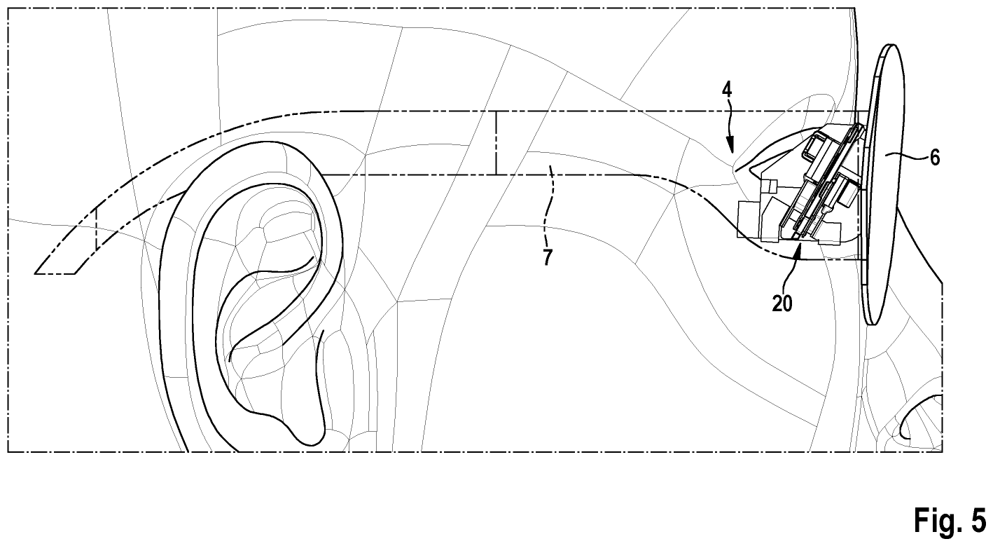

FIG. 5 illustrates the installation of projection module 20 shown in FIGS. 2 to 4 on a temple 7 of VR/AR smart glasses. Given a suitable design of the glasses, the compact design of projection module 20 allows for the mounting in direct proximity of the lens of the glasses, that is to say, also in front of hinge 4 of the temple. In addition, by virtue of its compact design, projection module 20 may also be installed in a manner that is twisted to a certain degree if this appears useful in the context of the higher-order overall system. For example, lens 6 in the installation situation illustrated in FIG. 5 has a lens inclination of 5°. Projection module 20 is then also mounted at an inclination of 5° on temple 7. The required defined alignment or orientation of projection module 20 in relation to lens 6 of the glasses is considerably simplified by external mechanical interface 212.

In conclusion, it should be stressed once again that the concept of a projection module according to the present invention is not restricted to the use in VR/AR smart glasses but may also be used for other applications that require an especially compact design and excellent heat dissipation characteristics.

1-12. (canceled)

13. A projection module, comprising:
an actuable laser module having at least one laser source configured to emit a laser beam of a predefinable intensity;
an actuable micromirror array configured to deflect the at least one laser beam;
a mounting support having a support front side and a support rear side; and
a beam-deflection system;
wherein:
the laser module is situated on the support front side,
the micromirror array is situated on the support rear side, and
the beam-deflection system is configured in such a way that the at least one laser beam is directed from the laser module on the support front side to the micromirror array on the support rear side.

14. The projection module as recited in claim 13, wherein the laser module is positioned on the support front side in such a way that the at least one laser beam is emitted parallel to the support front side, and the beam-deflection system is configured in such a way that the at least one laser beam is directed parallel to the support rear side onto the micromirror array.

15. The projection module as recited in claim 13, wherein the laser module and the micromirror array are situated and the beam-deflection system is configured in such a way that the at least one laser beam is directed in a U-shape from the laser module on the support front side to the micromirror array on the support rear side.

16. The projection module as recited in claim 13, wherein the mounting support has a through hole, and the beam-deflection system is positioned and configured in such a way that the at least one laser beam is directed from the laser module on the support front side through the through hole onto the micromirror array on the support rear side.

17. The projection module as recited in claim 13, wherein the beam-deflection system includes a plurality of optical elements whose interaction induces a beam deflection of the at least one laser beam.

18. The projection module as recited in claim 13, wherein the beam-deflection system is configured to decouple at least a partial beam of the at least one laser beam.

19. The projection module as recited in claim 18, wherein a light sensor including a photodiode, is positioned in a beam path of the at least one partial beam.

20. The projection module as recited in claim 13, wherein optical elements for the beam combining and/or beam aligning and/or beam shaping of the at least one laser beam are situated on the support front side between the laser module and the beam-deflection system.

21. The projection module as recited in claim 13, wherein electrical contacting of the laser module and/or the micromirror array and/or the light sensor is realized via at least one flexible circuit board, which is fixed in place on the mounting support.

22. The projection module as recited in claim 13, wherein the mounting support is equipped with at least one internal mechanical interface, which facilitates an adjusted mounting of the laser module and/or the micromirror array and/or the beam-deflection system on the mounting support.

23. The projection module as recited in claim 17, wherein the mounting support is equipped with at least one external mechanical interface, the external mechanical interface forming a reference surface for calibration and optical alignment of the laser module, the micromirror array, the beam-deflection system, and the optical elements for beam combining and/or beam aligning and/or beam shaping and facilitating an adjusted installation of the projection module in a higher-order overall system.

24. The projection module as recited in claim 23, wherein the at least one external mechanical interface is realized in the form of a mechanical stop and/or mechanical fastening arrangement so that, in an interaction with a corresponding mechanical interface of the higher-order overall system, it prevents a translatory movement in at least one direction in space and/or a rotatory movement about at least one direction in space.
